(19) United States
(12) Patent Application Publication
(10) Pub. No.: US 2021/0289182 A1
(43) Pub. Date: Sep. 16, 2021

(54) METHOD OF CONTROLLING PROJECTOR AND PROJECTOR

(71) Applicant: SEIKO EPSON CORPORATION, Tokyo (JP)

(72) Inventor: Tetsuro TOKUYAMA, Yufu-shi (JP)

(73) Assignee: SEIKO EPSON CORPORATION, Tokyo (JP)

(21) Appl. No.: 17/197,179

(22) Filed: Mar. 10, 2021

(30) Foreign Application Priority Data
Mar. 11, 2020 (JP) 2020-041632

(51) Int. Cl. H04N 9/31

(52) U.S. Cl. CPC H04N 9/3188; H04N 9/3185

(57) ABSTRACT

A method of controlling a projector configured to perform a scaling process on an input image to thereby project a projection image corresponding to the input image on a screen includes the steps of correcting a geometric configuration of the projection image with a correction amount, calculating, from the correction amount, a projection surface of the projection image corrected, and changing the scaling process so that an aspect ratio of the input image is reproduced in the projection surface.

The present application is based on, and claims priority from JP Application Serial Number 2020-041632, filed Mar. 11, 2020, the disclosure of which is hereby incorporated by reference herein in its entirety.

### BACKGROUND

### 1. Technical Field

The present disclosure relates to a method of controlling a projector, and a projector.

### 2. Related Art

JP-A-2005-123669 discloses a projection-type display device which performs a keystone distortion correction different in ratio between horizontal lines or between vertical lines of an input image on the input image different in aspect ratio from a display device (a liquid crystal panel).

When a geometric correction such as the keystone distortion correction is performed, the aspect ratio of an image on a screen is different from the aspect ratio of the input image in some cases. In these cases, there can increase a burden on a user of adjusting a device in order to project an appropriate image.

### SUMMARY

An aspect is directed to a method of controlling a projector configured to perform a scaling process on an input image to thereby project a projection image corresponding to the input image on a screen including the steps of correcting a geometric configuration of the projection image with a correction amount, calculating, from the correction amount, a projection surface of the projection image corrected, and changing the scaling process so that an aspect ratio of the input image is reproduced in the projection surface.

Another aspect is directed to a projector configured to perform a scaling process on an input image to thereby project a projection image corresponding to the input image on a screen including a correction processing section configured to correct a geometric configuration of the projection image with a correction amount, a projection surface calculation section configured to calculate, from the correction amount, a projection surface of the projection image corrected, and a scaling processing section configured to change the scaling process so that an aspect ratio of the input image is reproduced in the projection surface.

### BRIEF DESCRIPTION OF THE DRAWINGS

FIG. 1 is a perspective view for explaining a projector according to an embodiment.

FIG. 2 is a block diagram for explaining a basic configuration of the projector according to the embodiment.

FIG. 3 is a block diagram for explaining a basic configuration of an optical system.

FIG. 4 is a diagram for explaining a calculation method of a projection surface.

FIG. 5 is a diagram for explaining the calculation method of the projection surface.

FIG. 6 is a diagram for explaining an example of a panel image.

FIG. 7 is a diagram for explaining an example of a projection image corrected in a geometric configuration.

FIG. 8 is a diagram for explaining an example of a projection image changed in a scaling process.

FIG. 9 is a diagram for explaining an example of a panel image changed in a scaling process.

FIG. 10 is a flowchart for explaining an image processing method for each frame in the projector according to the embodiment.

FIG. 11 is a flowchart for explaining a method of controlling the projector according to the embodiment.

FIG. 12 is a block diagram for explaining a basic configuration of a projector according to another embodiment.

### DESCRIPTION OF EXEMPLARY EMBODIMENTS

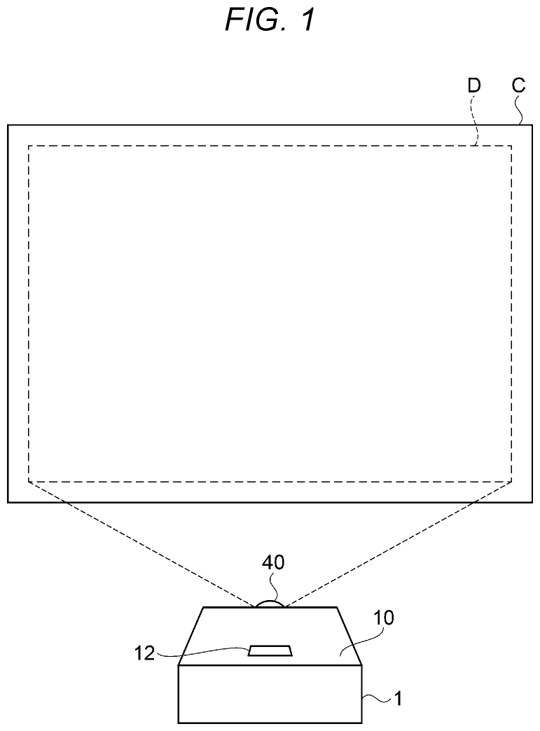

As shown in FIG. 1, a projector 1 according to an embodiment is provided with a chassis 10, an input device 12, and a projection device 40. The projection device 40 projects light representing a projection image D to thereby project the projection image D on a screen C. As the screen C, there can be adopted a flat surface such as a roll screen or a whiteboard.

The chassis 10 is a case for housing components of the projector 1 inside. The chassis 10 has, for example, a schematically rectangular solid shape. The input device 12 is an input device for receiving an operation by the user. As the input device 12, there can be adopted a variety of types of input devices such as a push button, a touch sensor, a keyboard, or a pointing device. Although the input device 12 is exposed on a surface of the chassis 10 in the example shown in FIG. 1, the input device 12 is not required to be provided to the chassis 10. For example, the input device 12 can include a remote controller using wireless communication or wired communication.

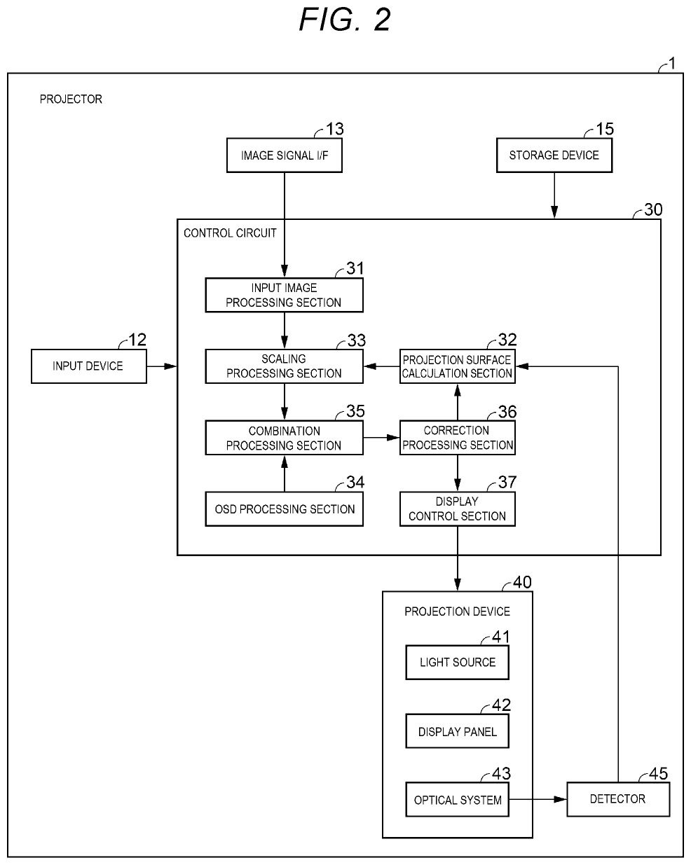

As shown in FIG. 2, the projector 1 is further provided with an image signal interface (I/F) 13, a storage device 15, and a detector 45. Via a communication link, an input image signal is input from a separate external device not shown to the image signal I/F 13 and is then output to a control circuit 30. The communication link is limited to neither the wired communication nor the wireless communication, but can also be a combination of the wired communication and the wireless communication. The image signal I/F 13 can include, for example, an antenna for wirelessly receiving a signal, a receptacle to which a plug of a cable for transmitting the signal is inserted, and a communication circuit for processing the signal.

The control circuit 30 forms a processing device of a computer for processing a necessary operation for an operation of the projector 1. The control circuit 30 executes a control program stored in, for example, the storage device 15 to thereby realize each of the functions described in the embodiment. As a processing device constituting at least a part of the control circuit 30, there can be adopted a variety of types of logical operation circuits such as a central processing unit (CPU), a digital signal processor (DSP), a programmable logic device (PLD), or an application specific integrated circuit (ASIC). The control circuit 30 can additionally be provided with a rendering engine, a graphics memory, and so on. The control circuit 30 can be formed of integrated hardware, or can be constituted by a plurality of hardware units separated from each other.

The storage device 15 is a computer-readable storage medium for storing a control program representing a series of processing necessary for the operation of the projector 1 and a variety of types of data. As the storage device 15, it is possible to adopt, for example, a semiconductor memory. The storage device 15 is not limited to a nonvolatile auxiliary storage device, and can include a volatile primary storage device such as a register or a cash memory incorporated in the CPU. At least a part of the storage device 15 can be formed of a part of the control circuit 30. The storage device 15 can be formed of integrated hardware, or can be constituted by a plurality of hardware units separated from each other.

The projection device 40 is provided with a light source 41, a display panel 42, and an optical system 43. The light source 41 includes a light emitting element such as a discharge lamp or a solid-state light source. The display panel 42 is a light modulation element having a plurality of pixels. As the display panel 42, a plurality of light modulation elements can be adopted. The display panel 42 modulates the light emitted from the light source 41 in accordance with the control by the control circuit 30 to thereby display an image. The display panel 42 is, for example, a liquid crystal light valve of a transmissive type or a reflective type. The display panel 42 can be a digital micromirror device for controlling the reflection of light of each pixel.

The projection image D corresponding to the image displayed on the display panel 42 is projected by the optical system 43 on the screen C. In other words, the optical system 43 projects the light modulated by the display panel 42 on the screen C to thereby display the projection image Don the screen C. The optical system 43 includes a variety of lenses, mirrors, and so on. As another configuration of the projection device 40, there can be adopted a configuration using a mirror device for scanning the screen C with the light thus modulated.

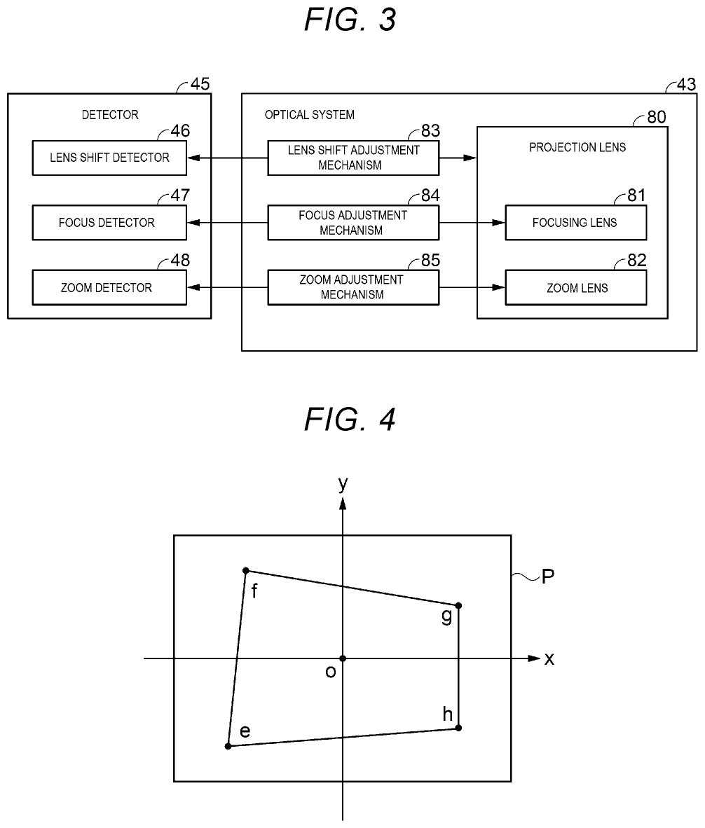

As shown in FIG. 3, the optical system 43 is provided with a projection lens 80 including a focusing lens 81 and a zoom lens 82, a lens shift adjustment mechanism 83, a focus adjustment mechanism 84, and a zoom adjustment mechanism 85. The lens shift adjustment mechanism 83 shifts the projection lens 80 in a direction perpendicular to an optical axis of the projection image D to thereby adjust the position of the projection surface which the projection image D occupies on the screen C. The lens shift adjustment mechanism 83 is provided with, for example, a motor driven in accordance with a drive signal output from the control circuit 30, and a gear for transmitting the drive of the motor to the projection lens 80.

The focus adjustment mechanism 84 drives the focusing lens 81 along the optical axis of the projection image D to thereby adjust the focal distance of the projection image D. The focus adjustment mechanism 84 is provided with, for example, a motor driven in accordance with a drive signal output from the control circuit 30, and a gear for transmitting the drive of the motor to the focusing lens 81. It is possible for the focus adjustment mechanism 84 to have a configuration of manually driving the focusing lens 81 by being directly operated by the user.

The zoom adjustment mechanism 85 drives the zoom lens 82 along the optical axis of the projection image D to thereby adjust the projection range of the projection image D. In the present embodiment, the projection range corresponds to a zoom magnification of the projection image D to be projected. The zoom adjustment mechanism 85 is provided with, for example, a motor driven in accordance with a drive signal output from the control circuit 30, and a gear for transmitting the drive of the motor to the zoom lens 82. It is possible for the zoom adjustment mechanism 85 to have a configuration of manually driving the zoom lens 82 by being directly operated by the user.

The detector 45 is provided with, for example, a lens shift detector 46, a focus detector 47, and a zoom detector 48. As a configuration of the optical system 43, the detector 45 detects at least any of a shift amount of the projection lens 80, a focal distance, and a projection range. The lens shift detector 46 detects the shift amount of the projection lens 80 based on the displacement of the lens shift adjustment mechanism 83 from a reference position. The focus detector 47 detects the focal distance based on the displacement of the focus adjustment mechanism 84 from a reference position. The zoom detector 48 detects the projection range based on the displacement of the zoom adjustment mechanism 85 from a reference position. The lens shift detector 46, the focus detector 47, and the zoom detector 48 can each be configured at low cost using, for example, a variable resistor. The shift amount, the focal distance, and the projection range can be detected using other detectors such as an encoder, or can be detected based on a drive signal of the control circuit 30.

As shown in FIG. 2, the control circuit 30 has an input image processing section 31, a projection surface calculation section 32, a scaling processing section 33, an on-screen display (OSD) processing section 34, a combination processing section 35, a correction processing section 36, and a display control section 37 as a logical structure. The input image processing section 31 performs signal processing on the input image signal input from the image signal I/F 13, wherein the signal processing includes a data format conversion such as a color conversion, and an image quality adjustment such as a brightness adjustment, a contrast adjustment, a sharpness adjustment, a color adjustment, or a gamma correction.

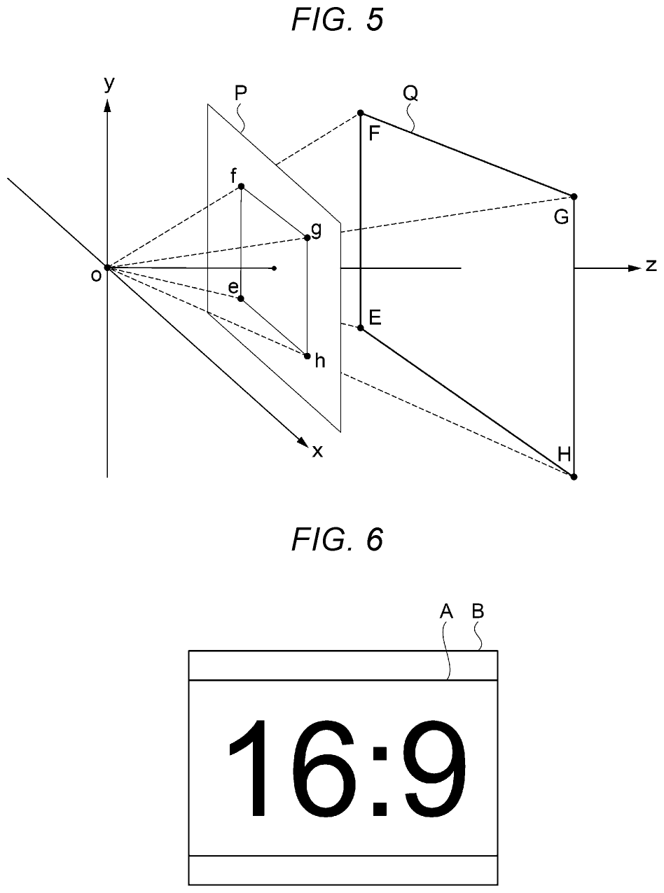

The projection surface calculation section 32 calculates the projection surface of the projection image D from an amount of correction of the geometric configuration of the projection image D obtained by the correction processing section 36. The projection surface calculation section 32 calculates four points e, f, g, and h on a plane P as a quadrangle representing the projection image D from the correction amount in an x-y coordinate system having an origin o as shown in, for example, FIG. 4. As shown in FIG. 5, the projection surface calculation section 32 defines the plane P perpendicular to the z axis by the detector 45 based on the configuration of the optical system 43 in the xyz coordinate system having the origin o. The z axis represents the optical axis of the optical system 43.

The projection surface calculation section 32 defines four points E, F, G, and H on four straight lines passing the origin o and the four points e, f, g, and h, respectively. The z coordinate of each of the four points E, F, G, and H is higher than the z coordinate of the plane P. As a premise, the projection surface which the projection image D occupies on the screen C has a rectangular shape. The projection surface calculation section 32 calculates the coordinate of each of the four points E, F, G, and H so that a plane Q defined by the four points E, F, G, and H becomes to have a rectangular shape in the xyz coordinate system. As described above, the projection surface calculation section 32 calculates the four points E, F, G, and H defining the plane Q based on the correction amount and the configuration of the optical system 43 to thereby calculate the projection surface in the three-dimensional space. Specifically, the projection surface calculation section 32 calculates the position of the projection surface in the three-dimensional space and the aspect ratio.

As shown in FIG. 6, the scaling processing section 33 generates a panel image B including an input image A by performing the scaling process on the input image signal on which the signal processing is performed by the input image processing section 31. The panel image B is displayed on the display panel 42 to thereby be projected on the screen C as the projection image D. In other words, the projector 1 performs the scaling process on the input image A to thereby project the projection image D corresponding to the input image A on the screen C.

The panel image B is defined as at least a partial display area of the display panel 42. In other words, the aspect ratio of the panel image B can arbitrarily be changed in accordance with an operation by the user on, for example, the input device 12, an aspect ratio of the input image, and so on. The scaling processing section 33 performs the scaling process as a two-dimensional coordinate transformation so that, for example, the input image A to be the largest in the display area is displayed. It should be noted that although the rectangular panel image B is shown in FIG. 6 in order to simplify the description, the panel image B can have a distortion in the display panel 42.

The scaling processing section 33 performs the scaling process on the input image signal so that the aspect ratio of the input image A is reproduced in a plane of an object space which coincides with the projection surface calculated by the projection surface calculation section 32. In the present embodiment, the projection surface which the projection image D occupies on the screen C can be assumed as a plane which is a projection object. In other words, the scaling processing section 33 changes a parameter of the scaling process in accordance with the fact that a change occurs in the projection surface calculated by the projection surface calculation section 32.

The OSD processing section 34 generates computer graphics corresponding to the control program as superimposition images by the OSD. The OSD processing section 34 generates the superimposition image including information representing the aspect ratio of the projection surface. For example, when the aspect ratio of the projection surface calculated by the projection surface calculation section 32 is 16:9, the OSD processing section 34 generates the characters of “16:9” as the superimposition image as shown in FIG. 6. As the aspect ratio of the projection surface, there can be adopted a ratio in length between the sides of the projection image D, or a ratio between width and height of the projection image D. Besides the above, the OSD processing section 34 can generate the superimposition image including a menu or information to be presented to the user.

The combination processing section 35 combines the signals respectively representing the panel image B and the superimposition image so as to superimpose the superimposition image generated by the OSD processing section 34 on the panel image B. When the superimposition image is generated by the OSD processing section 34, the signal representing the panel image B on which the superimposition image is superimposed is output by the combination processing section 35 to the correction processing section 36.

The correction processing section 36 corrects the geometric configuration of the projection image D into a rectangular shape with a correction amount with which the distortion provided to the projection image D on the screen C is dissolved. The correction processing section 36 corrects the geometric configuration of the projection image D with the correction amount decided in accordance with an operation by the user to the input device 12. Specifically, the correction processing section 36 corrects the geometric configuration of the panel image B output from the combination processing section 35 with a two-dimensional coordinate transformation so that the geometric configuration of the projection image D on the screen C becomes to have a rectangular shape in accordance with an operation by the user. The correction processing section 36 outputs a signal representing the panel image B having been corrected to the display control section 37.

The display control section 37 controls the projection device 40 so as to project the projection image D corresponding to the panel image B output from the correction processing section 36. Specifically, the display control section 37 generates the control signal for controlling the display panel 42 so as to display the panel image B based on a signal output from the correction processing section 36. It is possible for the display control section 37 to control at least any of the lens shift adjustment mechanism 83, the focus adjustment mechanism 84, and the zoom adjustment mechanism 85 in accordance with an operation by the user to the input device 12, or in accordance with the control program.

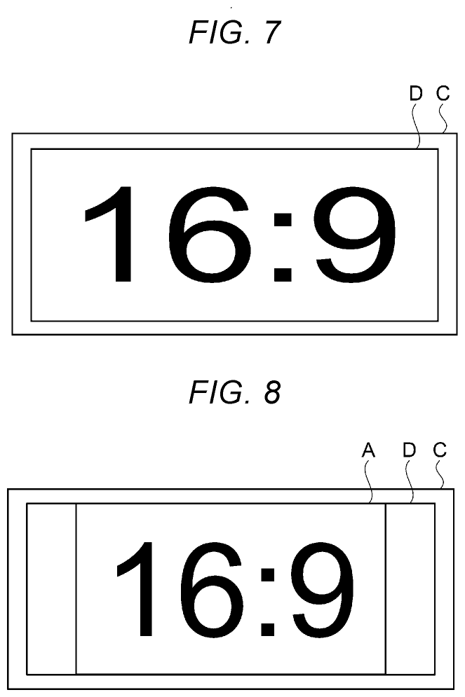

As shown in, for example, FIG. 7, the correction processing section 36 corrects the geometric configuration of the projection image D so that the aspect ratio of the projection image D substantially coincides with the aspect ratio of the screen C in accordance with an operation by the user. For example, the projection image D is an image corresponding to the input image A having the value of the aspect ratio of 16/9, but is corrected by the correction processing section 36 into a rectangular shape having a value of the aspect ratio higher then 16/9.

The projection surface of the projection image D corrected by the correction processing section 36 is calculated by the projection surface calculation section 32 from the correction amount obtained from the correction processing section 36. In particular, when the configuration of the optical system 43 is variable, the projection surface calculation section 32 calculates the position and the aspect ratio of the projection surface in the three-dimensional space based on the correction amount and the configuration of the optical system 43.

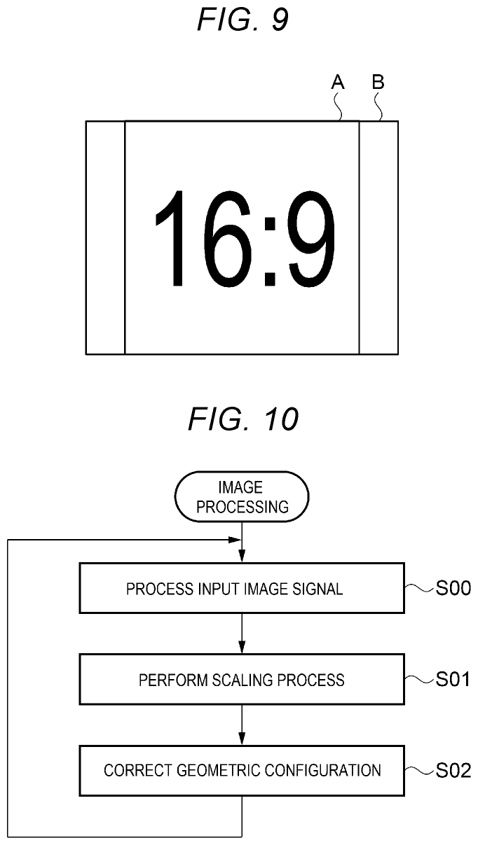

As shown in FIG. 8, the scaling processing section 33 changes the scaling process on the input image A so that the original aspect ratio of the input image A is reproduced in the projection surface calculated by the projection surface calculation section 32. The original aspect ratio is an aspect ratio defined by the input image signal to be input to the image signal I/F 13. For example, when the aspect ratio of the panel image B is 4:3 as shown in FIG. 9, the scaling processing section 33 changes the scaling process to the input image A so that the value of the aspect ratio in the panel image B becomes smaller than 4/3. It is possible for the scaling processing section 33 to change the scaling process so that the whole of the input image A is maximized in the projection surface. Thus, the visibility of the input image A is improved. As described above, the projection device 40 projects the projection image D on the screen C in the state in which the aspect ratio of the input image A is maintained.

An example of the series of image processing to be performed for each of the frames of the input image signal will hereinafter be described as a part of the method of controlling the projector 1 with reference to a flowchart shown in FIG. 10.

First, in the step S00, the input image processing section 31 processes the input image signal input from an external device or the like via the image signal I/F 13 to output the result to the scaling processing section 33. Specifically, the input image processing section 31 performs an image quality adjustment process such as a color correction on the input image A or a sharpness adjustment. In the step S01, the scaling processing section 33 generates the panel image B including the input image A by performing the scaling process on the input image A having been processed in the step S00. The display control section 37 controls the projection device 40 so as to project the projection image D corresponding to the panel image B. Thus, the projection device 40 projects the projection image D on the screen C.

In the step S02, the correction processing section 36 corrects the geometric configuration of the projection image D on the screen C into a rectangular shape with the correction amount corresponding to an operation by the user to the input device 12. In other words, the correction processing section 36 corrects the geometric configuration of the panel image B generated in the step S01 using the two-dimensional coordinate transformation. The projection device 40 projects the projection image D corresponding to the panel image B having been corrected, namely the projection image D having a rectangular shape on the screen C.

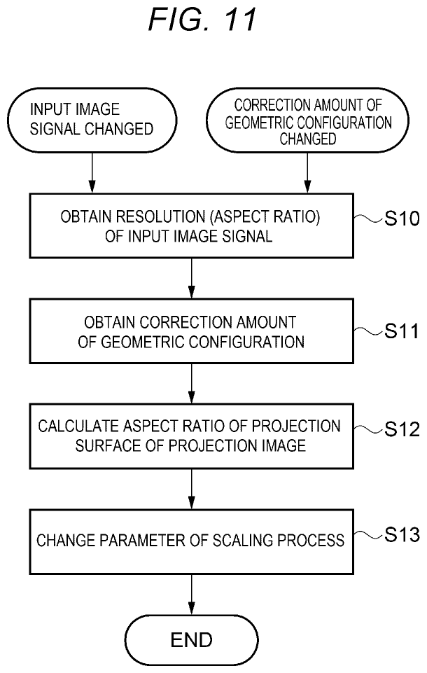

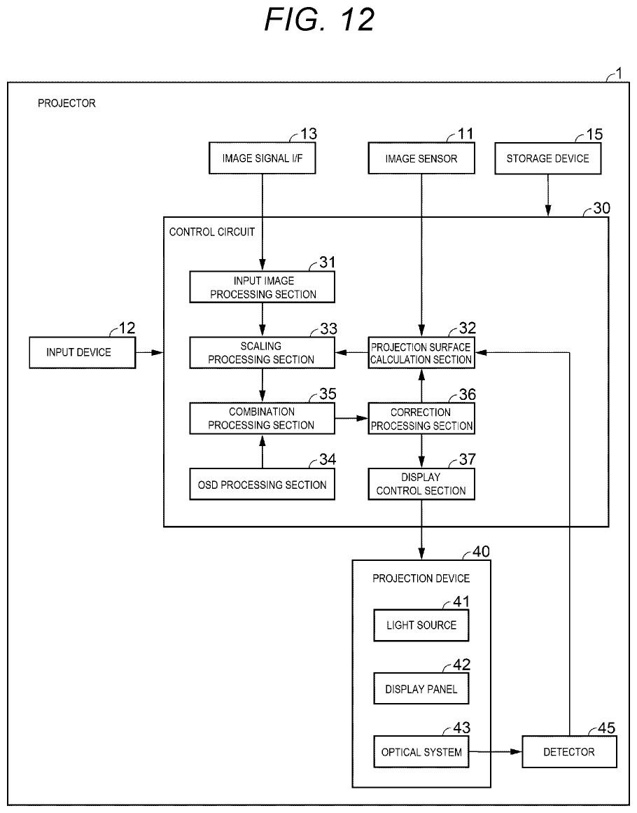

An example of a method of changing the parameter of the scaling process as a part of the method of controlling the projector 1 with reference to a flowchart shown in FIG. 11. The series of processes shown in FIG. 11 can be executed, for example, when the aspect ratio of the input image A has changed, or when the correction amount of the geometric configuration has changed in accordance with an operation by the user to the input device 12.

In the step S10, the scaling processing section 33 obtains the aspect ratio of the input image A from the input image signal input in the last step S00. In the step S11, the projection surface calculation section 32 obtains the correction amount of the geometric configuration of the projection image D having been corrected in the last step S02 from the correction processing section 36. In the step S12, the projection surface calculation section 32 calculates the projection surface in the three-dimensional space of the projection image D from the correction amount obtained in the step S11 and the configuration of the optical system 43.

In the step S13, the scaling processing section 33 changes the parameter of the scaling process on the input image A so that the original aspect ratio of the input image A is reproduced in the plane in the object space coinciding with the projection surface calculated in the step S12. Thus, the panel image B in which the aspect ratio of the input image A is reproduced in the projection surface is generated by the control circuit 30. The projection device 40 projects the projection image D corresponding to the panel image B image on the screen C in accordance with the control by the control circuit 30. The parameter of the scaling process changed in the step S13 is used in the scaling process in the step S01.

As described hereinabove, according to the projector 1 related to the present embodiment, even when the aspect ratio of the projection image D is changed by the correction processing section 36, the projection surface calculation section 32 calculates the projection surface of the projection image D on the screen C from the correction amount of the geometric configuration. Further, since the parameter of the scaling process is changed so that the aspect ratio of the input image A in the projection image D is reproduced by the scaling processing section 33, an appropriate image with respect to the input image signal is automatically projected. As described above, according to the projector 1, even when the aspect ratio of the projection surface is changed by the geometric correction, it is possible to project the appropriate image without increasing the burden on the user. Further, according to the projector 1, it is possible to omit a function of setting a type of the aspect ratio of the panel image B in accordance with the aspect ratio of the screen C.

Further, according to the projector 1, the OSD processing section 34 generates the information representing the aspect ratio of the projection surface calculated by the projection surface calculation section 32 as the superimposition image. The projection device 40 projects the information representing the aspect ratio of the projection surface as the superimposition image by the OSD. Thus, it is possible for the user to correct the geometric configuration of the projection image D on the screen C into an intended shape while checking the aspect ratio of the projection image D without using a mark, a measurement instrument, or the like.

Although the embodiment is hereinabove described, the present disclosure is not limited to the disclosure in the embodiment. The configuration of each section can be replaced with an arbitrary configuration having substantially the same function, and further, an arbitrary constituent in the embodiment can be omitted or added within the scope or the spirit of the present disclosure. As described above, according to the disclosure described above, a variety of alternative embodiments are made clear to those skilled in the art.

For example, as shown in FIG. 12, it is possible for the projector 1 to be provided with an image sensor 11 which takes the projection image D projected on the screen C to thereby generate a detection image. In this case, it is possible for the projection surface calculation section 32 to obtain the detection image as the correction amount of the geometric configuration of the projection image D. For example, the projection surface calculation section 32 defines the plane P corresponding to the detection image taking the center of the detection image as the origin o in FIG. 4. It is sufficient for the projection surface calculation section 32 to detect the four points e, f, g, and h on the plane P as the quadrangle representing the projection image D using the image processing on the detection image. It is possible for the projection surface calculation section 32 to calculate the four points E, F, G, and H forming the rectangle in the plane Q shown in FIG. 5 based on the detection image and the configuration of the optical system 43 to thereby calculate the projection surface in the three-dimensional space. In addition, it is possible for the correction processing section 36 to be arranged to automatically correct the geometric configuration of the projection image D with the correction amount for making the geometric configuration have a rectangular shape based on the detection image to be generated by the image sensor 11.

Further, it is possible for the scaling processing section 33 to be arranged to execute the scaling process on the panel image B on which the superimposition image to be generated by the OSD processing section 34 is superimposed. By the scaling process being performed on the superimposition image, it is possible for the projection device 40 to project the projection image D on the screen C in the state in which the aspect ratio of the superimposition image is maintained as shown in FIG. 8. Therefore, it is possible to improve the visibility of the superimposition image.

Further, it is possible for the correction processing section 36 to correct the projection image D so as to change only the size of the projection surface. In other words, it is possible for the correction processing section 36 to change the display range of the panel image B without performing the two-dimensional coordinate transformation on the panel image B. Thus, the degree of freedom when deciding the projection range of the projection image D is increased.

Besides the above, it is obvious that the present disclosure includes a variety of embodiments which are not described hereinabove such as a configuration obtained by applying the configurations described above to each other. The scope or the spirit of the present disclosure can only be determined by the elements of the present disclosure according to the appended claims appropriate from the above descriptions.

What is claimed is:

1. A method of controlling a projector configured to perform a scaling process on an input image to thereby project a projection image corresponding to the input image on a screen, the method comprising:
correcting a geometric configuration of the projection image with a correction amount;
calculating, from the correction amount, a projection surface of the projection image corrected; and
changing the scaling process so that an aspect ratio of the input image is reproduced in the projection surface.

2. The method of controlling the projector according to claim 1, wherein
the projection surface in a three-dimensional space is calculated based on the correction amount and a configuration of an optical system of projecting the projection image.

3. The method of controlling the projector according to claim 1, wherein
the geometric configuration is corrected into a rectangular shape.

4. The method of controlling the projector according to claim 1, wherein
the projection image including information representing an aspect ratio of the projection surface is projected.

5. The method of controlling the projector according to claim 4, wherein
the information representing the aspect ratio of the projection surface is projected as a superimposition image by on-screen display, and
the scaling process is performed on the superimposition image.

6. The method of controlling the projector according to claim 1, wherein
the scaling process is changed so that the input image is maximized in the projection surface.

7. The method of controlling the projector according to claim 1, wherein
the scaling process is performed on the input image to thereby generate a panel image to be displayed on a display panel, and the projection image corresponding to the panel image is projected on the screen.

8. A projector configured to perform a scaling process on an input image to thereby project a projection image corresponding to the input image on a screen, the projector comprising:
a correction processing section configured to correct a geometric configuration of the projection image with a correction amount;
a projection surface calculation section configured to calculate, from the correction amount, a projection surface of the projection image corrected; and
a scaling processing section configured to change the scaling process so that an aspect ratio of the input image is reproduced in the projection surface.
